(19) United States
(12) Patent Application Publication
(10) Pub. No.: US 2004/0254844 A1
(43) Pub. Date: Dec. 16, 2004

(54) Online viewing cart

(75) Inventor: Robert J. Torres, Colleyville, TX (US)

Correspondence Address: IBM CORPORATION (RHF), C/O ROBERT H. FRANTZ, P. O. BOX 23324, OKLAHOMA CITY, OK, 73123, US

(73) Assignee: International Business Machines Corporation, Armonk, NY

(21) Appl. No.: 10/460,431

(22) Filed: Jun. 12, 2003

(51) Int. Cl. G06F 17/60

(52) U.S. Cl. 705/26; 705/27

(57) ABSTRACT

A system and method for a viewing cart for linked information resources such as hyperlinked web pages, images, videos, and the like, in which a user is provided a multi-select control for selecting two or more linked information resources within a first information resource, an entry is created for each selected linked resource in a viewing cart list; and the view cart contents may be accessed and managed by the user for more convenient and efficient viewing of information of interest.

### BACKGROUND OF THE INVENTION

1. Field of the Invention

This invention relates to tools for viewing linked information resources such as hyperlinked web pages, documents, images, and the like.

2. Background of the Invention

Web browsing is a common activity, in which a user employs an arrangement of a web browser to search, view, and download web resources such as web pages, images, movies, audio files, etc., as shown in FIG. 1.

A user typically uses a web browser system (12) such as a personal computer (“PC”), web-enabled mobile telephone, or network-enabled personal digital assistant (“PDA”) which is equipped with a web browser program (e.g. Palm Blazer, Microsoft Internet Explorer, Netscape Navigator, etc.) and a network access arrangement (16) (e.g. dial-up modem, cable modem, wireless modem, etc., with an Internet Service Provider account) to access one or more “servers” (12, 14, 15) over a computer network (11) such as the World Wide Web or Internet. In some cases, this same arrangement (10), or one similar to it, may be employed to browse an “intranet”, which is similar to the Internet except that it is intended for use of employees within a corporate environment (e.g. a “private Internet”).

Although some systems and arrangements employ proprietary protocols in whole or part, most systems use a Hyper Text Transfer Protocol (“HTTP”) or Wireless Application Protocol (“WAP”) to retrieve linked resources from the servers (13, 14, 15) which may include documents (e.g. HTML, WML, PDF, text, etc.), images (e.g. GIF, TIFF, JPEG, etc.), audio files (e.g. WAV, MP3, etc.), and movies (e.g. AVI, MOV, etc.). Web resources may also employ various types of scripts (e.g. JavaScript, Active Server Pages, etc.), applets (e.g. Java), and forms to perform specialized functions such as input validation, computations, etc.

FIG. 2 illustrates the fundamental, simplified process of HTTP. Initially, a user selects a web address such as a Uniform Resource Locator (“URL”) or a direct Internet Protocol (“IP”) address value. This eventually results, after some resolution of the URL or web site name to an actual IP address value, in a “get” request (21) retrieve the base page associated with this address from a server.

The initial page is then returned to the browser from the server, usually via an IP address associated with the browser. An initial page such as an HTML index page usually includes one or more “linked” objects such as background pattern files, image files, etc., each of which has its own hyperlinked reference or address. The web browser, then, automatically requests (23) those linked objects, as well, which are returned (24) to the browser. The browser combines all of the linked objects and the base page to produce a displayed page to the user.

The user can then read or review the page, and may select a hyperlink to go to another page from the current page. This selection of a hyperlink results in this basic process being repeated by requesting a new page, obtaining all of the linked objects, etc.

FIG. 3 provides an illustration of a typical web browsing session (30). In this example, the user “points” his browser to a home page (31) for a news server, where there are some headlines and hyperlinks to categorized information. The user then sequentially visits all of the sub-pages on the web site according to the user's interests and need for information. For example, the user first selects a hyperlink to a sports news summary page (32), and from there selects a link to the baseball scores (33), and from there selects a link to watch highlight video clips (38) from the games played the previous evening. Then, the user selects a “back” navigation operation to return to the baseball scores pages (33) and eventually to the sports summary page (32) so that the user can take a link to see current golf standings (34).

When finished perusing the sports section of the web site, the user may use the “back” function or a “back to home page” link to return to the news home page (31). From there, the user may select hyperlinks to an economy news summary (35) page, and to a trading news page (36), and then back to the news home page (31).

Finally, the user may peruse a political news section (39) of the web site by selecting links from the home page (31), eventually to a news article about a trade dispute (37), and then he may point (38) his browser to another web site for other activities and information.

This example shows fourteen serial navigation operations which “hub” or extend from a centralized page such as a home page. Many sites, however, are arranged (40) to provide “deep links” to pages which are two or more levels deeper in the organization of the web site (if viewed in an ordered hierarchy), or which are peers to each other, as shown by the dotted lines in FIG. 4.

In a variation of our previous browsing example, assuming that the web site provider has provided such direct links or deep links, the user may save some time and effort by following a more direct and efficient browsing pattern (41, 42, 43, 44, 45, 46, 47). However, this browsing sequence would still be a serial set of navigation operations.

This tedious, serial approach to web browsing has become unacceptable as the content on the Internet and within intranets has grown tremendously, including incredible growth in the number of hyperlinks to other documents and web resources. Therefore, there is a need in the art for a more efficient method and system to browse hyperlinked resources over computer networks.

### BRIEF DESCRIPTION OF THE DRAWINGS

The following detailed description when taken in conjunction with the figures presented herein provide a complete disclosure of the invention.

FIG. 1 illustrates a typical arrangement of a client or browser system accessing one or more server systems via a computer network.

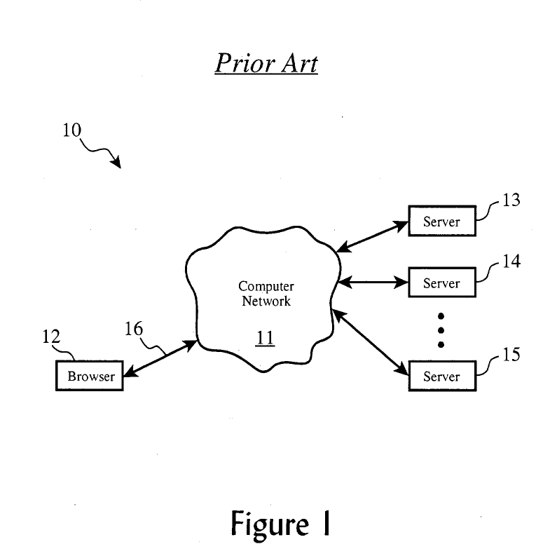

FIG. 2 provides a generalized overview of Hyper Text Transfer Protocol.

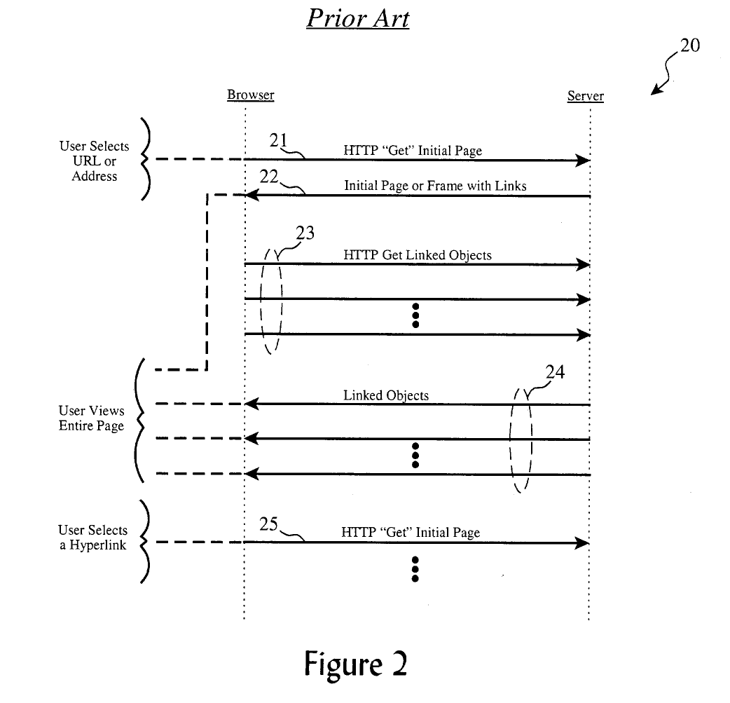

FIG. 3 shows an exemplary browsing pattern.

FIG. 4 shows an alternate browsing pattern with respect to that of FIG. 3.

FIG. 5 depicts the logical process of the present invention.

FIG. 6 illustrates one possible user interface according to the present invention.

FIG. 7 illustrates one possible viewing cart management user interface g to the present invention.

### SUMMARY OF THE INVENTION

The present invention allows a user to mark linked information and sections within a displayed web page for later viewing. Selected links are placed into a “viewing cart”, which can later be accessed. When the user has marked all the hyperlinks which he or she may be interested in visiting or viewing, the user may access the viewing cart which contains all of the links previously marked. Then, the user may visit each hyperlinked resource without having to wade through extraneous information which may have been presented on their original pages (e.g. advertisements, uninteresting links, etc.).

The view cart is dynamically created and managed, in a transparent manner, on behalf of the user either by a web server application, or by a function of the web browser. As the links to the original source information are preserved, it is unnecessary for the user to be aware of where the marked content is actually stored.

Viewing cart contents may be saved for later access, deleted, or otherwise re-organized. Storage may be local to the user's machine, or remotely on a server or database. Storage locally allows the user to view marked infonrmation in an “offline” state when access to the computer network is disabled.

The present invention may be used to add linked information to a user's viewing cart where all of the information is from a single web site or domain, as well as when the information is from multiple web sites and domains.

### DETAILED DESCRIPTION OF THE INVENTION

Prior to developing the present invention, several other technologies were considered for their applicability to solve the problem as described in the Background of the Invention, and to achieve the objectives of the present invention.

Shopping Cart Technology

Shopping cart software is the backbone of most e-commerce systems currently in place. A shopping cart function is usually a “server-side” function (e.g. it runs on the web server, not the browser), sometimes in conjunction with one or more browser-side or client-side scripts or plug-ins.

These e-shopping carts, nicknamed from the conventional shopping cart, are the front-end for the data containing a current order status for an online user of a web site where goods may be purchased. The online user is able to browse around at will through online advertisements and “catalog pages”, adding items to the cart as he or she finds them.

When the user is ready to make the purchase(s), the user selects a link to his or her personal shopping cart, which activates a user interface displaying the “contents” or items in the shopping cart (e.g. the previously selected items for sale). The user may review the list, make changes such as change quantities, and accept the list. Additional steps obtain payment and shipping information from the user, and the shopping cart application then processes the order via an electronic credit card or check transaction. Once a user has completed a purchase, the shopping cart software tallies up the total, calculates tax, adds shipping, if necessary, and charges the user the total amount.

Shopping carts are most often accessible from any page on the sponsoring website. These carts are often implemented as a server-side script and are written in a language such as Perl, ASP, or Java. A professional web programmer can easily develop a shopping cart without any outside help, though it may not be able to handle the credit card transactions. A website owner or operator can simply purchase the shopping cart software module from a third-party software vendor, which is commonly done. Another solution is to choose a web-hosting firm that offers shopping cart software.

While an online user browses around a e-commerce website, his or her shopping cart is keeping record of all items the user has selected to purchase, usually by depositing “cookies” in the web browser's persistent memory. When the user decides to “checkout”, the user is directed to the cart, and the data from the cookies is presented to the user in the form of a bill, or invoice. The user can, at this time, choose to remove any unwanted items from the cart. When the user is ready to process the order, the shopping cart tallies up the totals, adds the appropriate tax and shipping, and then submits the transaction for credit card processing.

In short, an online shopping cart is simply a set of pages that allow a user to browse a product, purchase the product and make the electronic transaction. They work in a variety of ways, though the most common variety is a server-side script. These scripts can be written in any language that the server is able to execute.

Shopping carts, however, are not generally compatible from one website to another For example, a single shopping cart cannot be used to browse and purchase books from Amazon.com and from BamnesAndNoble.com. Additionally, shopping cart are not appropriate for dynamically building a list of hyperlinks for later visitation or perusing; they are only suitable for building lists of items to purchase. Thus, although the user interface for selecting items within a web page is somewhat useful for our purposes, the shopping cart paradigm does not meet our objectives.

Offline Browsing Technology

“Offline browsing” is a feature that has been lightly implemented in the major browser (i.e. Internet Explorer, Netscape Navigator, etc.), but which is available to some degree in specialty products. In its simplest form, offline browsing is simply having the browser retrieve and store a web page and all of its associated linked objects in a local cache which is available even when the network connection for the browser is disabled or disconnected.

In other words, offline browsers essentially download and save part of the website into the user's persistent memory, re-writing some of the references for linked object so that they “point” to the local cache instead of the original web site. The user, then, may later view cached pages while his or her network connection is disconnected or otherwise inaccessible (e.g. while on an airplane).

Offline browsers, however, do not offer a simple or easy user interface for “marking ” or selecting web site content to automatically download. Additionally, their main function is caching of web content, and as such, require considerable persistent memory resources to locally store web objects such as pages, images, video clips,etc. Therefore, offline browsers do not, in and of themselves, meet the objectives of the present invention to provide a more efficient user interface and method for selecting items to be placed into a viewing cart.

“Look Ahead” Caching

Similar to offline browsing, “look ahead” caching tries to minimize user wait time to access a selected page by anticipating which links on a page are most likely to be selected by the user, and by automatically requesting those pages and their linked object prior to the user actually selecting a link. Then, if and when the user actually selects an anticipated link, the linked document or web content is already in local cache and can be displayed more quickly (e.g. without waiting for download of all the linked objects in the resource).

The anticipation of which links are most likely to be selected can be based upon site-wide expectations (e.g. most often selected links by all users viewing a certain page), or by user characteristics (e.g. user's preferences or user's habits and trends).

Look ahead caching, however, does not simplify the browsing pattern (e.g. the sequence of links selected during a browsing session), but merely decreases the latency of the display of web documents when each link is selected.

Our “Viewing Cart” Technology

Our invention combines some of the user interface techniques of shopping carts with techniques of dynamic page generation and page re-writing to achieve a new tool for web browsing. Additionally, it may be combined with e-commerce shopping carts, offline browsers, or look ahead caching tools to achieve even greater user efficiency and ease-of-use.

Through using our viewing cart, a user is allowed to select viewable content via a multiselect mechanism within a web browser display as follows:

1. Selected items are added to a “viewing cart”.

2. Content from multiple subsections, subdomains, or buried levels of a site can be added to the viewing cart.

3. Once a user has completed selection of items for the viewing cart, a “viewing wizard” guides the user through the selected sections of content in a preferred manner (e.g. sequentially, or simultaneously by spawning multiple browser frames).

Other features can be combined with the viewing cart, e.g., downloading a selected item as a Portable Document File, printing a page, etc. This provides a number of advantages and efficiencies to the user, including:

1. a user is able to see the list of selected content prior to engaging the “viewing wizard”;

2. a user is able to edit the list or content of the viewing cart; and

3. content displayed within the viewing cart may maintain a “breadcrumb” trail to allow a user to move at will through the content list.

Logical Processes of Our Viewing Cart

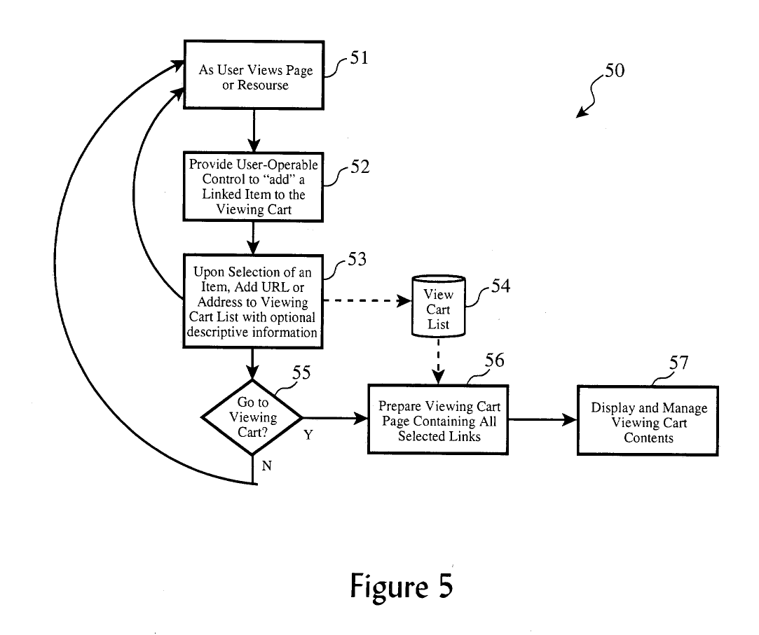

From a generalized viewpoint, our viewing cart provides a method (50) as shown in FIG. 5. As a user views (51) a page or resource from a server over a computer network, a user-operable control is provided (52) to the user to allow addition of a hyperlinked item to the user's viewing cart. There are several embodiment options for providing this control, including but not limited to:

(a) providing a check-box or other user-selectable icon next to each hyperlinked item in a page in the source code of the page (requires web site owner design and maintenance, and is useful for allowing quick, initial browsing and later return for more careful review of marked information);

(b) rewriting the web page by a program such as a server-side script, a portal application program, or a browser function to add a selectable icon as described in (a) (does not require web site owner design or maintenance); or

(c) providing a browser-side function which does not modify the appearance of a standard page, but allows the user to activate a special function such as right-clicking with a mouse on an item and providing a pop-up dialog box to add the item to the viewing cart (requires no server-side support or maintenance).

More details for embodiment options are discuss in the following paragraphs. As the user selects or marks (53) hyperlinks for addition to his or her viewing cart, a viewing cart list (54) is updated to include the address, path or URL of each selected item, including any displayed information from the original page. For example, if a user selects text which reads “US Masters Golf Standings”, which is hyperlinked to an address “www.news-source.com/masters₁₃ standings”, an entry such as:

DISPLAYED₁₃ INFO(1): “US Masters Golf Standings”

ADDRESS (1):“http://www.news-source.com/masters₁₃ standings”

is made in the viewing cart list. The viewing cart list is maintained by a server, and intermediary portal, or by the client (e.g. depositing one or more cookies).

When the user elects (55) to go to his or her viewing cart, such as by clicking on a viewing cart icon or by performing a menu operation (e.g. clicking “Tools” then “Viewing Cart”), the viewing cart list (54) is then accessed in order to prepare (56) a viewable page or web resource containing the selected information. This dynamically created resource may simply be an HTML page with the hyperlinked source from the list, or may be a more sophisticated user interface such as those often provided for database management, especially if the contents of the viewing cart are numerous.

Finally, the contents of the viewing cart are displayed and managed by the user.

Viewing Cart Operation—Viewing Items in the Cart

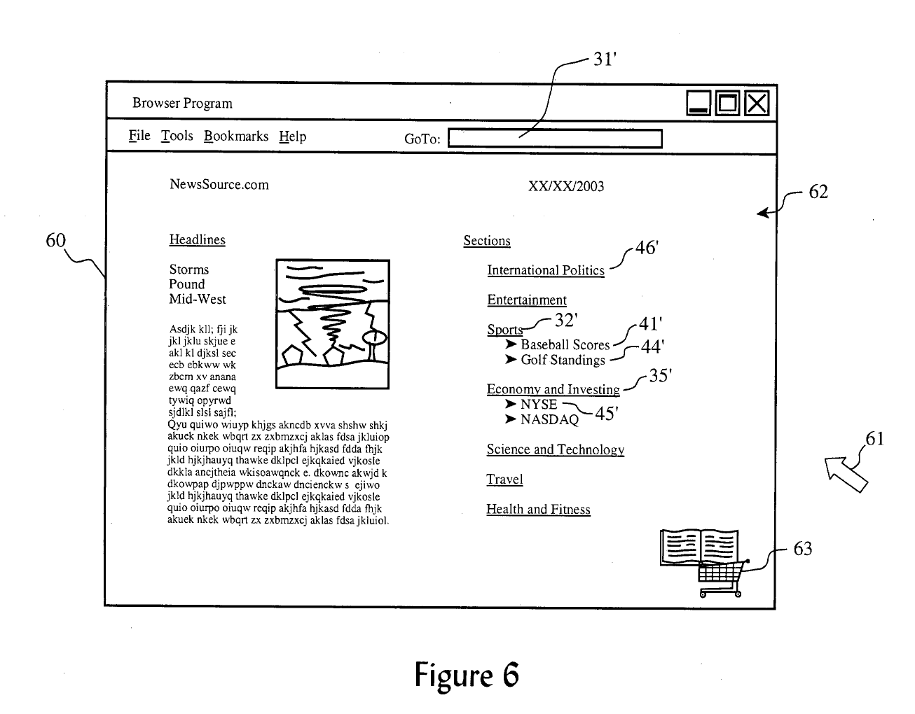

Turning to FIG. 6, consider an example operation of our viewing cart starting from a hypothetical home page for “News-Source.com” (62). First, the user would use a frame (60) or window of a web browser program to point to the address of the home page, usually by entering a URL (31′) into a “GoTo” or “Address” field in the window.

In this example, the news home page (62) has a portion dedicated to headliner news, and a number of links to sections or departments (e.g. politics, economy, sports), as previously discussed in other examples. The user may, with the implementation of the present invention, use the system pointer (61) or cursor to select multiple links for adding to the viewing cart, such as links to International Politics (46′), Sports Summary (32′), Baseball Scores (41′), Golf Standings (44′), Economy news summary (35′), and New York Stock Exchange report (45′). Selection may be made as previously described, and each selection results in the selected displayed information and hyperlink data being recorded into the user's viewing cart list.

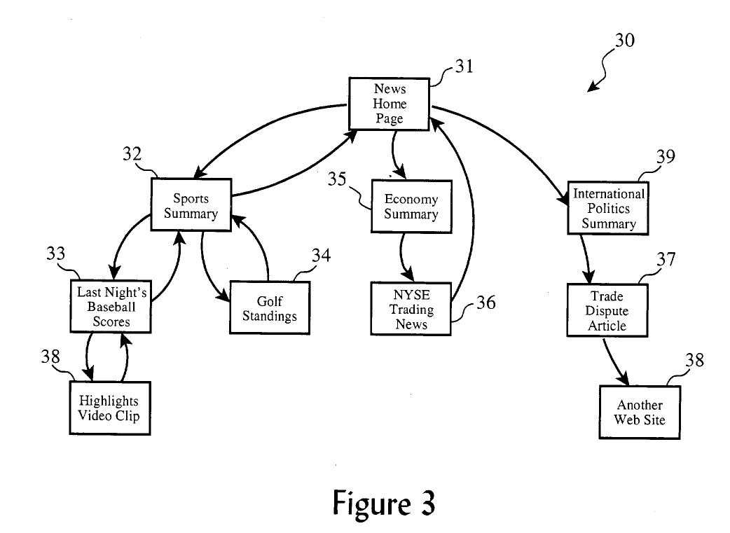

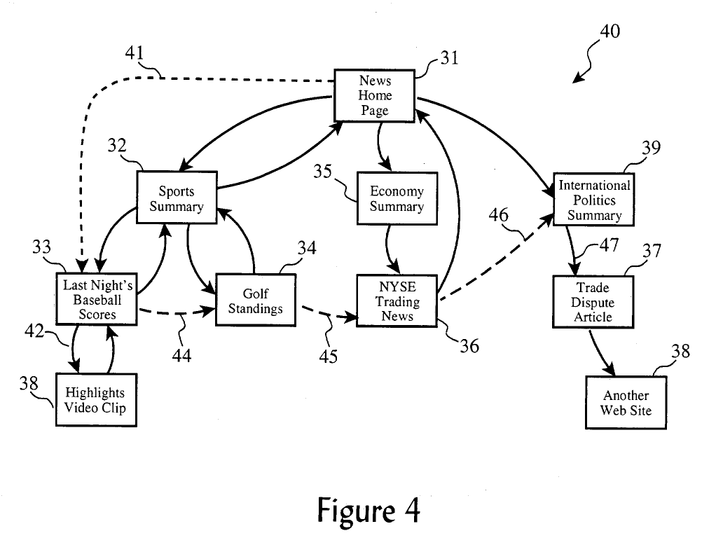

Next, instead of following the serial navigation path as shown in FIGS. 3 or 4, the user may access his or her viewing cart, such as by selecting a “Viewing Cart” option from the “Tools” drop down menu, performing a right click in the window and selecting “Viewing Cart”, selecting a viewing cart icon (63), or other suitable method of invoking the viewing cart manager.

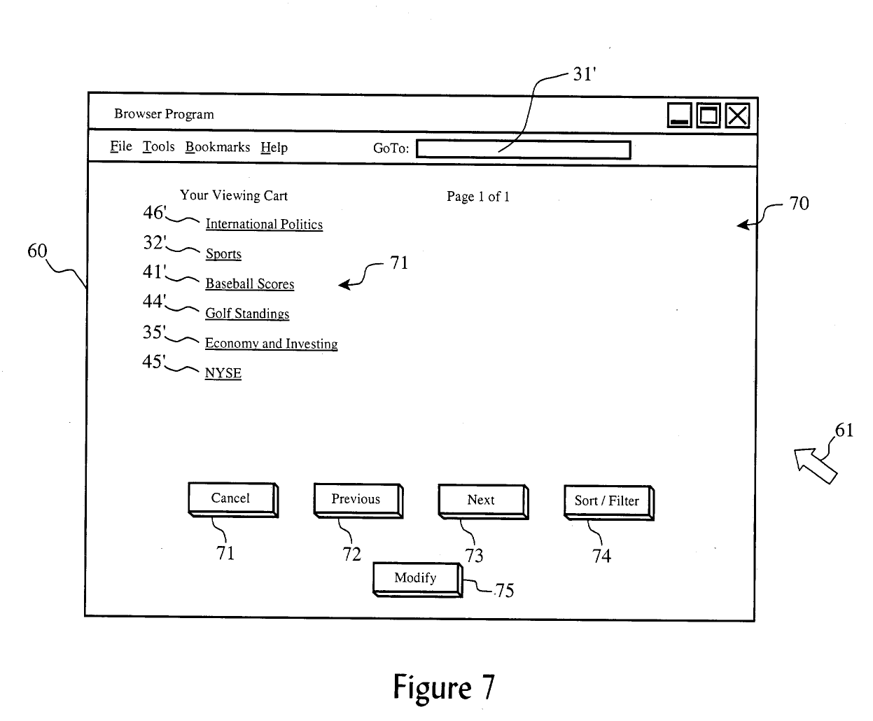

FIG. 7 illustrates an example implementation of the viewing cart manager user interface. This custom page is created using the contents of the viewing cart list, displaying the originally displayed objects (e.g. text, graphics, etc.), encoded with the original hyperlink references. In our preferred embodiment, the contents (70) of the viewing cart management user interface is a list (71) of the selected links (46′, 32′, 41′, 44′, 35′, 45′). Each of these list entries, then, is a selectable object in the page which, upon selection, activates the hyperlink and leads to the display of the linked information.

According to another optional aspect of the present invention, the viewing cart management user interface (70) contains one or more icons or drop down list options to cancel (71) (e.g. return to viewing original page), sequence through the list automatically (72, 73) (e.g. previous entry, next entry selection), set preferences for sorting the list and filtering the contents (74) (e.g. suppress advertisements, sort by newest posting date, automatically refresh and retrieve up-to-date information, etc.), and to modify (75) the list (e.g. save the list, delete items from the list, etc.)

As the viewing cart is not specific to any one web site or domain, it can be used to gather links to marked information from multiple web sites, each link being added to the viewing cart as it is marked. Table 1 shows an example block of text for such a gathering of links from differing domains or web sites, wherein underlined text represents hyperlinked text.

TABLE 1
Example Multi-site Viewing Cart Contents

| Site | Page | Data |
|---|---|---|
| NewsSource | “International Politics” | MM/DD/YYYY |
| XYZ Newspaper | “Sports Roundup-Golf” | MM/DD/YYYY |
| StocksOnline | “NYSE Day in Review” | MM/DD/YYYY |
| The Economic Advisor | “Bullish Outlook by Pros” | MM/DD/YYYY |

Viewing Cart Operation—Managing Items in the Cart

According to one advanced, optional aspect of the present invention, the user is provided with an option to “manage” or manipulate the contents of the viewing cart, including but not limited to:

(a) adding items to the list—allows the user to add manually entered addresses or addresses from bookmarks to the contents of the viewing cart;

(b) deleting items from the list—allows the user to manually delete entries from the viewing cart;

(c) sorting viewing cart contents—allows the user to set one or more preferences to sort the contents of the viewing cart, such as ascending/descending order, by date, by size, by content rating (e.g. news, family, adult, etc.), by relevance to interest terms, maximum posting age, etc.;

(d) filtering or suppressing list contents—allows the user to set one or more preferences to filter or suppress display of certain items in the viewing cart, including any or all of the criteria discussed in (c) above; and

(e) organizing shopping cart contents—allows the user to organize or group viewing cart contents into folders, categories, etc., as well as to save and retrieve viewing cart lists and contents.

Embodiment Alternatives

The logical processes and user interfaces of the present invention may be realized in a number of different manners, including but not limited to the following embodiment options:

(a) as a server-side module, application program or servlet provided by the web server itself, which allows any browser to take advantage of a viewing cart, and may include modifications to the pages themselves such as check boxes for selectable items, downloadable scripts to implement cart management, etc.;

(b) as part of an intermediary portal which rewrites the pages as they are accessed by the browser in transit from the server, through the portal to the browser, adding check boxes, scripts, etc., as described in (a) above;

(c) as a browser-side applet, script, plug-in, or browser-integrated function which provides pop-up dialogs, drop-down lists, and other forms of user interfaces to achieve the functionality of the invention for all web pages accessed, regardless of support provided (or not provided) by the originating server; or

(d) as a combination of any of the above options (e.g. partial server-side application with downloadable browser plug-in, server-side application with supporting portal, etc.).

The present invention provides a user with a “viewing cart” in which hyperlinks to selected information are stored for more convenient perusing. Those skilled in the art will readily recognize that the examples and preferred embodiment detail disclosed herein do not represent the full scope of the present invention, nor the only applications of the invention, and that many variations of the fuinctionality and methods discussed may be made without departing from the spirit and the scope of the invention. Therefore, the scope of the present invention should be determined by the following claims.

What is claimed is:

1. A method for providing a viewing cart for linked information resources comprising the steps of:
providing a multi-select control for selecting two or more linked information resources within a first information resource;
responsive to selection of a linked information resource using said multi-select control, recording an entry in a viewing cart list associated with said selected linked information resource; and
creating a viewing cart management information resource containing said entries in said viewing cart list.

2. The method as set forth in claim 1 wherein said step of providing a multi-select control for selecting two or more linked information resources within a first information resource comprises providing a control within a web page.

3. The method as set forth in claim 1 wherein said step of recording an entry in a viewing cart list comprises recording a hyperlink.

4. The method as set forth in claim 1 wherein said step of creating a viewing cart management information resource comprises creating a web page containing one or more selectable hyperlinks.

5. The method as set forth in claim 1 further comprising the step of providing one or more management functions for said viewing cart management.

6. The method as set forth in claim 5 wherein said management functions are selected from the list of adding an item to the viewing cart, deleting an item from the viewing cart, sorting the contents of the viewing cart, filtering the contents of the viewing cart, saving the contents of the viewing cart, and retrieving contents into the viewing cart.

7. The method as set forth in claim 1 further comprising the step of providing a sequential navigation function to allow a user to access the linked information resources in the viewing cart.

8. The method as set forth in claim 1 further comprising the step of providing a multi-spawn function to allow a user to access the linked information resources in the viewing cart using simultaneously spawned instances of a web browser.

9. The method as set forth in claim 1 wherein said step of creating a viewing cart management information resource containing entries in said viewing cart list comprises creating entries from a plurality of web sites or domains.

10. A computer readable medium encoded with software for providing a viewing cart for linked information resources, said software performing the steps of:
providing a multi-select control for selecting two or more linked information resources within a first information resource;
responsive to selection of a linked information resource using said multi-select control, recording an entry in a viewing cart list associated with said selected linked information resource; and
creating a viewing cart management information resource containing said entries in said viewing cart list.

11. The computer readable medium as set forth in claim 10 wherein said software for providing a multi-select control for selecting two or more linked information resources within a first information resource comprises software for providing a control within a web page.

12. The computer readable medium as set forth in claim 10 wherein said software for recording an entry in a viewing cart list comprises software for recording a hyperlink.

13. The computer readable medium as set forth in claim 10 wherein said software for creating a viewing cart management information resource comprises software for creating a web page containing one or more selectable hyperlinks.

14. The computer readable medium as set forth in claim 10 further comprising software for providing one or more management functions for said viewing cart management.

15. The computer readable medium as set forth in claim 14 wherein said software for providing management functions comprises software for providing a management function selected from the list of adding an item to the viewing cart, deleting an item from the viewing cart, sorting the contents of the viewing cart, filtering the contents of the viewing cart, saving the contents of the viewing cart, and retrieving contents into the viewing cart.

16. The computer readable medium as set forth in claim 10 further comprising software for providing a sequential navigation function to allow a user to access the linked information resources in the viewing cart.

17. The computer readable medium as set forth in claim 10 further comprising software for providing a multi-spawn function to allow a user to access the linked information resources in viewing cart using simultaneously spawned instances of a web browser.

18. The computer readable medium as set forth in claim 10 wherein said software for creating a viewing cart management information resource containing entries in said viewing cart list comprises software for creating entries from a plurality of web sites or domains.

19. A viewing cart system comprising:
a multi-select control capable of selecting two or more linked information resources within a first information resource;
a view cart list generator configured to, responsive to selection of a linked information resource using said multi-select control, record an entry in a viewing cart list associated with said selected linked information resource; and
a viewing cart manager configured to create a view cart contents information resource containing said entries in said viewing cart list.

20. The system as set forth in claim 19 wherein said multi-select comprises a control within a web page.

21. The system as set forth in claim 19 wherein said viewing cart list generator is configured to record a hyperlink.

22. The system as set forth in claim 19 wherein said viewing cart manager is configured to create a web page containing one or more selectable hyperlinks.

23. The system as set forth in claim 22 wherein said viewing cart manager is configured to create a web page containing one or more selectable hyperlinks from a plurality of web sites and domains.

24. The system as set forth in claim 19 further comprising one or more management functions for said viewing cart contents.

25. The system as set forth in claim 23 wherein said management functions are selected from the list of adding an item to the viewing cart, deleting an item from the viewing cart, sorting the contents of the viewing cart, filtering the contents of the viewing cart, saving the contents of the viewing cart, and retrieving contents into the viewing cart.

26. The system as set forth in claim 19 further comprising a sequential navigation function configured to allow a user to access the linked information resources in the viewing cart.

27. The system as set forth in claim 19 further comprising a multi-spawn function configured to allow a user to access the linked information resources in the viewing cart using simultaneously spawned instances of a web browser.
